(19) United States
(12) Patent Application Publication
(10) Pub. No.: US 2014/0104613 A1
(43) Pub. Date: Apr. 17, 2014

(54) SPECTRAL CALIBRATION METHOD

(71) Applicant: MILTON ROY COMPANY, Ivyland, PA (US)

(72) Inventors: Michael J. Birnkrant, Rocky Hill, CT (US); Marcin Piech, East Hampton, CT (US)

(73) Assignee: MILTON ROY COMPANY, Ivyland, PA (US)

(21) Appl. No.: 13/653,610

(22) Filed: Oct. 17, 2012

(51) Int. Cl. G01J 3/42

(52) U.S. Cl. 356/402

(57) ABSTRACT

An example method of spectral calibration includes directing light from a light source though a gas, detecting an optical density of the light that has passed through the gas using a detector, and calibrating the detecting by adjusting an optical path length.

### BACKGROUND

This disclosure relates generally to determining a quality of a gas.

High-quality gas is typically worth more than low-quality gas. If gas is offered for sale, its price may depend on its quality. Determining the quality of other gases such as atmospheric gas, indoor air, etc., may be useful for environmental reasons.

Components are the chemically independent constituents of a gas. Natural gas, an example type of gas, is made of several components, some of which are hydrocarbons. The quality of natural gas may be based on the enthalpy of combustion of its individual components.

One technique for determining the quality of gas involves separation of individual components of the gas. The separation technique is not suitable for use in some environments, such as when measuring gas within a pipeline. Another technique for determining the quality of gas measures light that has been directed through, and not absorbed by, the gas. The light not absorbed by the gas is spatially dispersed by wavelength and forms a modified light spectrum that is projected onto a detector. The modified light spectrum is compared to the light's actual light spectrum to determine the absorbance spectrum of the fluid.

### SUMMARY

An example method of spectral calibration includes directing light from a light source though a gas, detecting an optical density of the light that has passed through the gas using a detector, and calibrating the detecting by adjusting an optical path length.

A method of spectral calibration includes determining a first absorbance spectrum for a gas using light having a first optical path length, determining an second absorbance spectrum for the gas using light having a second, different optical path length, determining a calibrated absorbance spectrum for the gas by comparing the first and second absorbance spectra, and comparing the calibrated absorbance spectrum to a known spectrum to identify instrument and measurement error. The corrected absorption spectrum can then be used to obtain physical properties of the gas.

An example gas component meter includes a light source, a housing, and a detector configured to detect light from the light source that has passed through a gas within the housing to the detector. A distance between the light source and the detector is adjusted to calibrate measurements of the light by the detector.

### DESCRIPTION OF THE FIGURES

The various features and advantages of the disclosed examples will become apparent to those skilled in the art from the detailed description. The figures that accompany the detailed description can be briefly described as follows:

FIG. 1 shows an example gas component meter having a first optical path length.

FIG. 2 shows the gas component detector of FIG. 1 having a second optical path length.

FIG. 3 shows an example method of spectral calibration.

FIG. 4 shows a highly schematic view of how the transmission percentages are used to determine quality.

### DETAILED DESCRIPTION

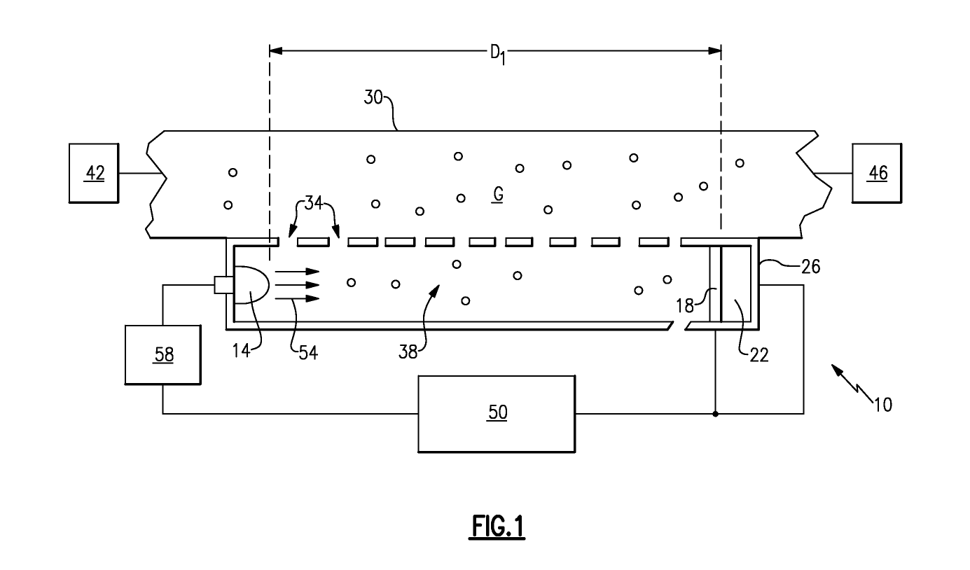

Referring to FIG. 1, an example gas component meter assembly 10 includes an infrared light source 14, a filter 18, and a detector 22 within a housing 26. The housing 26, in this example, is secured to a gas pipeline 30. Apertures 34 within the pipeline 30 and the housing 26 permit gas to communicate between an interior 38 of the housing 26 and the pipeline 30.

Gas G communicates through the pipeline 30 from a supply 42 to a destination 46. In this example, the gas G is natural gas. The supply 42 is a utility company. The destination 46 is a home or business.

The example meter 10 determines the composition of the natural gas within the interior 38 (and thus the composition of gas within the pipeline 30). The composition is used to determine the quality of the natural gas within the interior 38 and the pipeline 30.

In one example, a provider of the supply 42 utilizes the quality information when determining how much to charge the destination 46 for the gas G. The meter 10 is mounted to the pipeline 30 between the supply 42 and the destination 46. In other examples, the meter 10 may be utilized at location of the supply 42, at the location of the destination 46, or at some other location.

The meter 10 includes a controller 50 that is operationally linked to the infrared light source 14, the filter 18, and the detector 22. To monitor the components of the natural gas within the interior 38, the controller 50 initiates movement of infrared light waves 54 within the meter 10. The waves 54 propagate from the infrared light source 14. The waves 54 are mid-infrared spectrum waves.

In this example, the distance D between the infrared light source 14 and the detector 22 is the optical path length of the waves 54. As the waves 54 move through the gas G toward the detector 22, components in the gas G absorb some of the light. For the wavelengths that pass through the filter 18, the detector 22 detects the light that has not been absorbed by components in the gas G. The controller 50 utilizes this information to determine the percentage of the waves 54 that have been transmitted through the gas G to the detector. The percentages detected by the detector 22 represent the percentages of the waves 54 that have not been absorbed by components in the gas G.

The controller 50 then compares the spectrum of waves detected by the detector 22 to the spectrum of waves 54 initially transmitted by the infrared light source 14. The comparison reveals the components of the gas G.

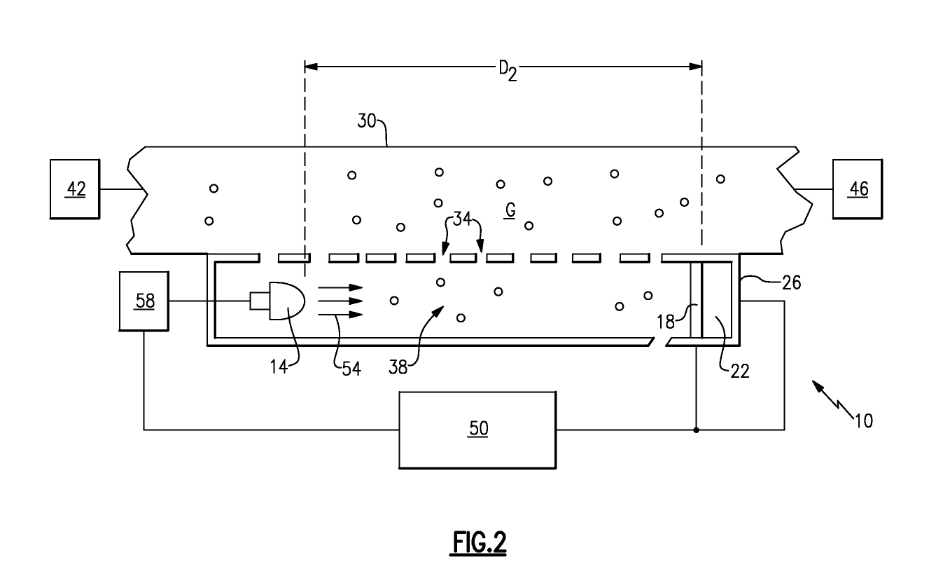

The example controller corrects for deviations in the spectrum of wavelengths initially transmitted from the infrared light source 14. In one example, the controller 50 prompts an actuator 58 to adjust the infrared light source 14 from a first position (FIG. 1) that is a distance D₁ from the detector 22 to a second position (FIG. 2) that is a distance D₂ from the detector 22. A person having skill in this art and the benefit of this disclosure would understand actuators suitable for moving the infrared light source 14 between the first position and the second position. In another example, the detector 22 may be moved (by another actuator) relative to the actuator 58.

The infrared light source 14 generates waves 54 when in both the first position and the second position. The intensity of the waves 54 is recorded when the infrared light source 14 is in both the first position and in the second position. In this example, the absorption of the waves 54 is then related to concentrations of components using Beer's Law, the relationships of which have been reproduced in Equation 1 (below) for ease of reference:

$$O . D . = - Log ( \frac{I ( λ )}{{I}_{0} ( λ )} ) = α ( λ ) {c}_{i} d \qquad Equation 1$$

In Equation 1, O.D. is the measured optical density, α(λ) is the absorption coefficient in cm²/mol, cᵢ is component concentration in mol/cm³, and d is the optical path length in cm.

Optical path length and optical density are directly related. Accordingly, under normal operation, a change in the optical path length from the distance D₁ to the distance D₂ yields a proportional change in the measured optical density. In one example, if the controller 50 records change in the optical density that deviate from this linearly proportional relationship, the meter 10 should be checked for proper operation. Thus, change in optical path length facilitates detector 10 self-diagnostic feature.

The changes in the optical path length facilitate greater operating range of the detector 10. In another example, measured optical density may be excessively high. Under this condition, detector receives insufficient IR radiation preventing determination of gas quality. Decrease in the optical path length would result in lower optical density. This in turn would allow more IR radiation to illuminate the detector according to the Beer's Law, Equation 1 facilitating gas quality measurement. Similarly, path length could be increased to allow greater detector sensitivity.

In yet another example, the controller 50, can be programmed with information indicating the relationship between optical path length and optical density according to Equation 1. Consequently, changes in the path length distance from D₁ to D₂ can be used to compensate for errors within the device.

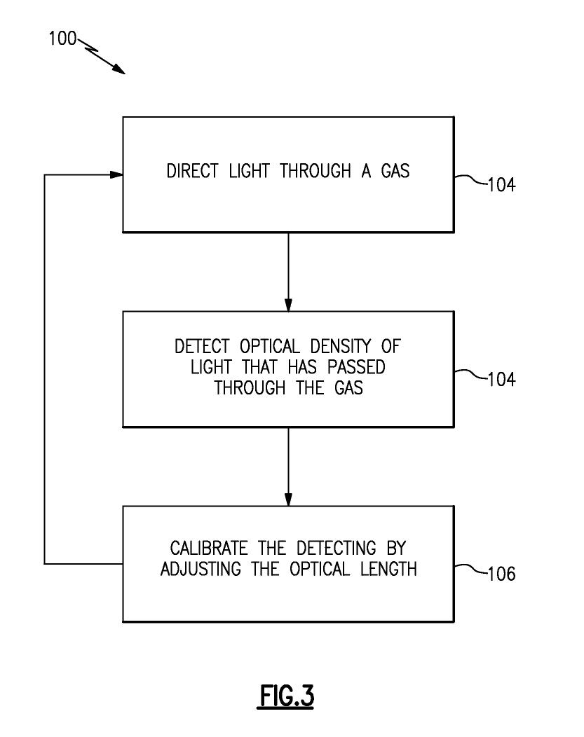

Referring to FIG. 3, an example method 100 of spectral calibration includes a step 102 of directing light from a light source though a gas. The method 100 then detects an optical density of the light that has passed through the gas using a detector and a step 104. At a step 106, the method 100 calibrates the detecting by adjusting an optical path length. The calibrating corrects for system errors, which may cause result in inaccurate readings of optical densities.

A more specific example, may include determining optical densities for a gas using light having a first optical path length, and light having a second optical path length. A calibrated optical density for the gas is then determined by comparing the measurements at the first optical path length and the second optical path length.

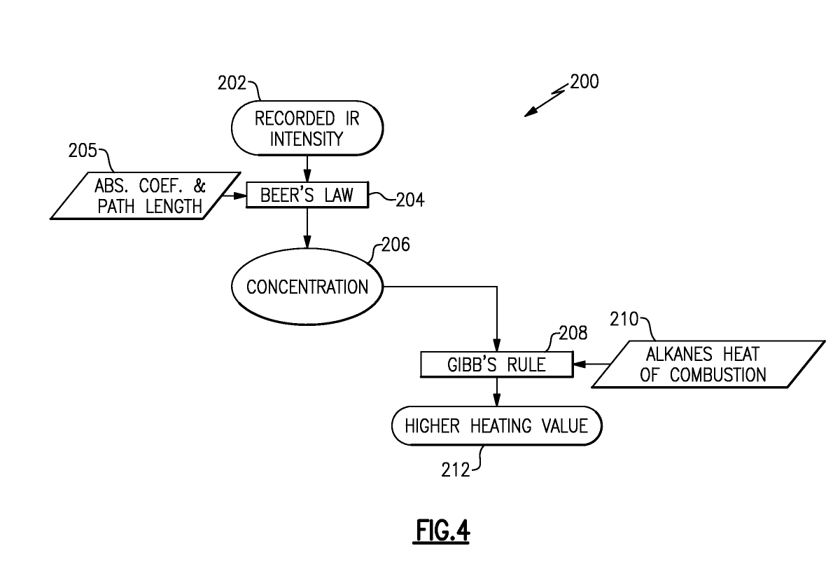

In one example, an operator may be interested in ultimately determining the quality of the test gas, which may be a natural gas. In such an example, method 200 described in FIG. 4 could be employed.

Referring to FIG. 4, a method 200 utilizes IR transmission to determine the quality of natural gas. The method 200 inputs the IR transmission intensities from a step 202 to a step 204.

The step 204 utilizes Beer's law to determine the concentrations of components using Equation 1 and absorption coefficients and path length from step 205.

Beer's law supplies component concentrations at step 206. This information is then used as the input to step 208, the Gibb's rule summarized in Equation 2.

ΔH_{Natural Gas}=ΣᵢcᵢΔH_{Combustion,i} Equation 2

In Equation 2, ΔH_{Combustion,i} is the alkane heat of combustion for alkane i expressed in kJ/mol from step 210 and cᵢ is the alkane concentration in mol/cm³. In principle, the simple molar addition of the individual heats of combustion gives rise to the Higher Heating Value, 212.

In some examples, the energy flow rate of the mixture of gases is given by:

$${Q}^{\dot{ideal}} = \frac{\dot{V}}{Z ( T , P )} ( {ρ}^{ideal} Δ {H}^{ideal} ) \qquad Equation 3$$

In Equation 3, Q^{ideal} is the energy flow rate given as a function of the volumetric flow rate; \dot{V}; compressibility factor, Z(T,P); the density, ρ^{ideal}; and the mixture heat of combustion equivalent to Higher Heating Value, ΔH^{ideal} The energy content of natural gas is an intensive thermodynamic property. A volume of natural gas has N+1 degrees of freedom, where N is the number of constituents that make up the gas mixture. In order to calculate, the exact energy content value, N+1 measurements are required. In a typical natural gas sample this would mean greater than nine independent measurements. This measurement of nine or more wavelengths corresponds to monitoring the composition of natural gas components from methane (CH3) to octane (C8H18) or higher. In a more specific example of the method 200, the algorithm development for determining the Higher Heating Value or gas quality at step 212 is composed of two equations, Beer's law at step 204 and Gibb's rule at step 208. The data flow between the two equations is shown in FIG. 4.

Specifically, the system of linear equations corresponding to the components of the gas needs to be solved. The algorithmic development for calculating the Higher Heating Value of a multispecies natural gas mixture is as follows.

The expansion of Beer's law at a given wavelength to take into account multiple gas species is given below.

O.D._{λ}_{₁}=α_{1,λ}_{₁}c₁l₁+α_{2,λ}_{₁}c₂l₂+ . . . α_{i,λ}_{₁}cᵢl₁ Equation 4

This expression states that the absorption of infrared light at a particular wavelength is the summation of individual component absorptions.

The same expression is valid at a different wavelength:

O.D._{λ}_{₂}=α_{1,λ}_{₂}c₂l₁+α_{2,λ}_{₂}c₂l₁+ . . . +α_{i,λ}_{₂}cᵢl₁ Equation 5

Both these equations are linear. The optical density and absorption coefficients are unique and different for each wavelength and gas mixture. However, the concentration of the gas species remains constant in each equation. Thus, a system of linear equations can be compiled to convert absorption to concentration. The system of linear equations can be converted to matrix form as shown below:

$$[ \begin{matrix}O . D {.}_{{λ}_{1}} \\ ⋮ \\ O . D {.}_{{λ}_{j}}\end{matrix} ] = [ \begin{matrix}{α}_{1 , {λ}_{1}} {l}_{1} & … & {α}_{i , {λ}_{1}} {l}_{1} \\ ⋮ & ⋱ & ⋮ \\ {α}_{1 , {λ}_{j}} {l}_{1} & … & {α}_{i , {λ}_{j}} {l}_{1}\end{matrix} ] [ \begin{matrix}{c}_{1} \\ ⋮ \\ {c}_{i}\end{matrix} ] \qquad Equation 6$$

A simpler representation of Equation 6 is:

O̅.̅D̅.̅= α̅l̅₁̅c̅ Equation 7

Accounting for baseline instrument error, this becomes:

( O̅.̅D̅.̅₁+ O̅.̅D̅.̅ₑ̅ᵣ̅ᵣ̅ₒ̅ᵣ̅)= α̅l̅₁̅ c̅ Equation 8

Measurement at a second optical path length incurs the same error yielding:

( O̅.̅D̅.̅₂+ O̅.̅D̅.̅ₑ̅ᵣ̅ᵣ̅ₒ̅ᵣ̅)= α̅l̅₂̅ c̅ Equation 9

Combination of the two measurements at the two different optical paths leads to error cancellation giving:

( O̅.̅D̅.̅₂− O̅.̅D̅.̅₁̅)= Δ̅O̅.̅D̅.̅= α̅(̅l̅₂̅−̅l̅₁̅)̅ c̅= α̅Δ̅l̅ c̅ Equation 10

Two methods are available to solve this expression for the concentration vector, c̅. If the matrix is square than the solution to the equation above relies on inverting the operator:

c̅= Δ̅O̅.̅D̅.̅( α̅Δ̅l̅⁻¹) Equation 11

The solution above exists for a well defined system. In practice, a system of equations is either over or under determined. In this case an approximation of the solution needs to be made to fit the observed data. This method is normally referred to as the least squares method and is shown below (The superscript T refers to the transpose of the matrix Δ̅l̅):

c̅=( α̅Δ̅l̅^{T} α̅Δ̅l̅)⁻¹ α̅Δ̅l̅^{T} Δ̅O̅.̅D̅.̅ Equation 12

The method can be extended to a plurality of path lengths. In the case of a plurality of wavelengths the method described above will measure the IR transmission at more than two distinct path lengths. The IR transmission at more than two path lengths is then used to correct for instrument deviations more accurately. The correction is then applied to the measurement of optical density that is used in the calculation of the physical properties of the gas.

Approaches in the past have relied on determining regions of the infrared spectra that could be speciated. In other words, concentrations of all species within a natural gas were determined individually. Only then was the higher heating value calculated. By contrast, some example methods disclosed herein remove this limitation. Specifically, these example methods are applicable to convoluted spectral ranges. Convolution is due to multiple alkane absorption coefficients at a particular wavelength contributing to the overall absorption coefficient at a particular wavelength. In this region or with an apparatus that measures a convoluted spectrum, speciation is difficult. However, gas quality still can be determined. This is accomplished by taking the dot product and minimizing the Euclidean Normal, ∥ α̅Δ̅l̅ c̅− Δ̅O̅.̅D̅.̅′̅∥, instead of determining gas species. The higher heating value for the mixture is then the dot product between c̅, and the heats of combustions of hydrocarbon components.

The higher heating value for natural gas mixture can be determined to an arbitrary accuracy by calculating the Euclidean Normal.

The use of the method described above and minimizing the Euclidean Normal to calculate natural gas quality are features of the disclosed examples. These features were used when evaluating a set of wavelengths in the range of eight to ten microns.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. A method of spectral calibration, comprising:
directing light from a light source though a gas;
detecting an optical density of the light that has passed through the gas using a detector; and
calibrating the detecting by adjusting an optical path length.

2. The method of claim 1, wherein the calibrating comprises identifying variations in a detected optical path length from a calculated optical path length.

3. The method of claim 2, wherein the calculated optical path length is determined using Beer's Law.

4. The method of claim 1, wherein the adjusting comprises adjusting a distance between the light source and the detector.

5. The method of claim 1, wherein the gas is natural gas.

6. The method of claim 1, including calculating a quality of the gas using information from the detecting.

7. The method of claim 1, wherein the detecting comprises determining a transmission percentage.

8. A method of spectral calibration, comprising:
determining a first absorbance spectrum for a gas using light having a first optical path length;
determining an second absorbance spectrum for the gas using light having a second, different optical path length;
determining a calibrated absorbance spectrum for the gas by comparing the first and second absorbance spectra; and
comparing the calibrated absorbance spectrum to a known spectrum to identify a physical property of the gas.

9. The method of claim 8, wherein determining the calibrated absorbance spectrum comprises identifying variations in a detected optical path length from a calculated optical path length.

10. The method of claim 8, wherein the calibrated absorbance spectrum is determined using Beer's Law.

11. The method of claim 8, including adjusting a distance between a light source and a detector to change between the first and second optical path lengths.

12. The method of claim 8, wherein the gas is natural gas.

13. The method of claim 8, including calculating a quality of the gas using the calibrated absorbance spectrum.

14. A gas component meter, comprising:
a light source;
a housing; and
a detector configured to detect light from the light source that has passed through a gas within the housing to the detector, wherein a distance between the light source and the detector is adjusted to calibrate measurements of the light by the detector.

15. The gas component detector of claim 14, wherein the gas is a natural gas.

16. The gas component detector of claim 14, wherein the distance between the detector and the light source is comprises the optical path length.

17. The gas component detector of claim 14, the distance is adjustable between a first set position and a second set position.
